(19) United States
(12) Patent Application Publication
(10) Pub. No.: US 2024/0324057 A1
(43) Pub. Date: Sep. 26, 2024

(54) METHOD AND DEVICE USED FOR WIRELESS COMMUNICATION

(71) Applicants: Jinfang ZHANG, Shanghai (CN); Xiaobo ZHANG, Shanghai (CN)

(72) Inventors: Jinfang ZHANG, Shanghai (CN); Xiaobo ZHANG, Shanghai (CN)

(73) Assignee: SHANGHAI LANGBO COMMUNICATION TECHNOLOGY COMPANY LIMITED, Shanghai (CN)

(21) Appl. No.: 18/736,461

(22) Filed: Jun. 6, 2024

Related U.S. Application Data
(63) Continuation of application No. PCT/CN2022/140563, filed on Dec. 21, 2022.

(30) Foreign Application Priority Data
Dec. 21, 2021 (CN) 202111572593.5

(51) Int. Cl. H04W 76/27; H04W 76/40

(52) U.S. Cl. CPC H04W 76/27; H04W 76/40

(57) ABSTRACT

A first node receives a first message; and enters into RRC_Inactive state as a response to receiving the first message; where whether to receive data units via a first RLC bearer in the RRC_Inactive state is related to whether the first message configures a first bearer and a type of the first RLC bearer; before receiving the first message the first RLC bearer is associated to the first bearer; when the first message configures the first bearer and the type of the first RLC bearer is a first type, data units are not received via the first RLC bearer in the RRC_Inactive state; when the first message configures the first bearer and the type of the first RLC bearer is a second type, data units are received via the first RLC bearer in the RRC_Inactive state. This application significantly reduces UE power consumption.

### CROSS REFERENCE TO RELATED APPLICATIONS

This application is the continuation of the international patent application No. PCT/CN2022/140563, filed on Dec. 21, 2022, and claims the priority benefit of Chinese Patent Application No. 202111572593.5, filed on Dec. 21, 2021, the full disclosure of which is incorporated herein by reference.

### BACKGROUND

### Technical Field

The present application relates to a method and a device used in wireless communication systems, and in particular to a method and device for transmitting MBS services while in RRC_Inactive state in wireless communications.

### Related Art

The RRC_Inactive (RRC_INACTIVE) state is a newly introduced radio resource control (RRC) state in New Radio (NR). When a UE (i.e., User Equipment) enters the RRC_Inactive state, the UE can retain part of the network configuration information. When there arrives some traffics, the UE can perform data transmission after re-entering into RRC_CONNECTED state. Not until Rel-16 will data transmission in an RRC inactive state be supported in the 3rd Generation Partner Project (3GPP) Radio Access Network (RAN).

The feature of multicast/broadcast transmission is not supported in the earliest version(s) of the fifth Generation (5G), that is, the Rel 15 and Rel 16, but in many significant application scenarios, such as public safety and mission critical, the application of Vehicle-to-Everything (V2X), software delivery and group communications, the one-to-many transmission feature of multicast/broadcast communications can enhance the system performance and user experience in a striking way. To support multicast/broadcast communications, 5G broadcast evolution was discussed between the 3GPP RAN #78 plenary and RAN #80 plenary, and a Study Item (SI) of the architecture evolution of 5G broadcast services was adopted by the Service and System Aspects (SA) #85 session. To support reliable multicast/broadcast service (MBS) transmission, the 3GPP has conducted studies in Rel-17 on MBS transmissions in RRC_CONNECTED state. In order to further reduce UE power consumption, the 3GPP started to discuss supporting MBS in RRC_Inactive state in Rel-18.

### SUMMARY

The inventors have found through researches that while in the RRC_Connected state the UE can be configured to receive MBS services via unicast, and when the UE enters into the RRC_Inactive state from the RRC_Connected state, a unicast reception cannot effectively improve the transmission efficiency, and, if the UE is meanwhile configured to receive MBS services via multicast, it has to monitor both the unicast and the multicast transmissions, which can significantly increase the power consumption of the UE.

The present application discloses a solution to receive MBS services only via multicast when the UE is in the RRC_Inactive state, which can achieve the beneficial effect of reducing the power consumption of the UE. Though originally targeted at a Uu air interface, the present application is also applicable to a PC5 air interface. Additionally, the adoption of a unified solution for various scenarios, including but not limited to uplink communications, contributes to the reduction of hardcore complexity and costs. In the case of no conflict, the embodiments of a first node and the characteristics in the embodiments may be applied to any other node, and vice versa. What's more, the embodiments in the present application and the characteristics in the embodiments can be arbitrarily combined if there is no conflict. Particularly, for interpretations of the terminology, nouns, functions and variables (unless otherwise specified) in the present application, refer to definitions given in TS36 series, TS38 series and TS37 series of 3GPP specifications.

The present application provides a method in a first node for wireless communications, comprising:
receiving a first message; and
entering into RRC_Inactive state as a response to receiving the first message;
herein, whether to receive data units via a first RLC bearer in the RRC_Inactive state is related to whether the first message configures a first bearer and a type of the first RLC bearer, before receiving the first message the first RLC bearer is associated to the first bearer; when the first message does not configure the first bearer, data units are not received via the first RLC bearer in the RRC_Inactive state; when the first message configures the first bearer and the type of the first RLC bearer is a first type, data units are not received via the first RLC bearer in the RRC_Inactive state; when the first message configures the first bearer and the type of the first RLC bearer is a second type, data units are received via the first RLC bearer in the RRC_Inactive state; data units transmitted via an RLC bearer of the first type are identified by a unicast RNTI, while data units transmitted via an RLC bearer of the second type are identified by a non-unicast RNTI.

In one embodiment, the first node is in RRC_Connected state prior to receiving the first message.

In one embodiment, the above method is suitable for an entry into the RRC_Inactive state from the RRC_Connected state.

In one embodiment, in the method described above the UE does not receive the data units by means of a Radio Link Control (RLC) bearer of a first type, which can significantly reduce the UE power consumption.

In one embodiment, in the method described above the UE does not receive the data units by means of a Radio Link Control (RLC) bearer of a first type, which can improve the wireless resource utilization.

In one embodiment, in the method described above the UE receives data units by means of an RLC bearer of a second type, which can effectively support MBS transmission.

In one embodiment, in the method described above the UE which is in RRC_Inactive state receives the data units, which can reduce the UE complexity.

According to one aspect of the present application, comprising:
updating an RLC bearer that is associated to the first bearer according to the type of the first RLC bearer as a response to receiving the first message;
herein, when the type of the first RLC bearer is the first type, the first RLC bearer is removed from the RLC bearer that is associated to the first bearer; when the type of the first RLC bearer is the second type, the association between the first RLC bearer and the first bearer is maintained.

In one embodiment, the above method changes a bearer type of the first bearer.

In one embodiment, the above method of removing the first RLC bearer of the first type from an RLC bearer that is associated to the first bearer upon entry into the RRC_Inactive state can effectively reduce the UE power consumption.

According to one aspect of the present application, comprising:
determining whether to deactivate the first RLC bearer according to the type of the first RLC bearer as a response to receiving the first message;
herein, the first RLC bearer is deactivated only when the type of the first RLC bearer is a former of the first type and the second type.

In one embodiment, the above method does not change the bearer type of the first bearer.

In one embodiment, the above method of deactivating the first RLC bearer of the first type upon entry into the RRC_Inactive state can effectively reduce the UE power consumption.

According to one aspect of the present application, comprising:
transmitting a second message, the second message being used for a request for resuming RRC connection; and
receiving a third message as a response to transmitting a second message, the third message indicating that the first node enters into RRC_Connected state; and
activating the first RLC bearer as a response to receiving the third message;
herein, the type of the first RLC bearer is the first type.

In one embodiment, the above method of activating the first RLC bearer of the first type upon entry into the RRC_Connected state can reduce the signaling overhead.

In one embodiment, the above method of activating the first RLC bearer of the first type upon entry into the RRC_Connected state can restore the configuration of the first bearer quickly.

According to one aspect of the present application, comprising:
as a response to receiving the first message, adding a second RLC bearer that is associated to the first bearer when the first bearer is associated only to the first RLC bearer and the first RLC bearer is of the first type before receiving the first message;
herein, data units are received via the second RLC bearer in the RRC_Inactive state; a type of the second RLC bearer is the second type.

In one embodiment, the above method of receiving data units by means of the second RLC bearer can effectively support MBS transmission while in the RRC_Inactive state.

According to one aspect of the present application, comprising:
stopping monitoring of a physical downlink control channel addressed to the unicast RNTI in the RRC_Inactive state;
herein, data units transmitted via an RLC bearer of the first type are scheduled by a physical downlink control channel addressed to the unicast RNTI.

In one embodiment, the above method is effective in saving UE power.

According to one aspect of the present application, comprising:
the first bearer being a multicast MRB.

The present application provides a first node for wireless communications, comprising:
a first receiver, receiving a first message; and entering into RRC_Inactive state as a response to receiving the first message;
herein, whether to receive data units via a first RLC bearer in the RRC_Inactive state is related to whether the first message configures a first bearer and a type of the first RLC bearer; before receiving the first message the first RLC bearer is associated to the first bearer; when the first message does not configure the first bearer, data units are not received via the first RLC bearer in the RRC_Inactive state; when the first message configures the first bearer and the type of the first RLC bearer is a first type, data units are not received via the first RLC bearer in the RRC_Inactive state; when the first message configures the first bearer and the type of the first RLC bearer is a second type, data units are received via the first RLC bearer in the RRC_Inactive state; data units transmitted via an RLC bearer of the first type are identified by a unicast RNTI, while data units transmitted via an RLC bearer of the second type are identified by a non-unicast RNTI.

The present application provides a method in a second node for wireless communications, comprising:
transmitting a first message, the first message indicating an entry into RRC_Inactive state;
herein, whether the receiver of the first message receives data units via a first RLC bearer in the RRC_Inactive state is related to whether the first message configures a first bearer and a type of the first RLC bearer; before receiving the first message the first RLC bearer is associated to the first bearer; when the first message does not configure the first bearer, data units are not received via the first RLC bearer in the RRC_Inactive state; when the first message configures the first bearer and the type of the first RLC bearer is a first type, data units are not received via the first RLC bearer in the RRC_Inactive state; when the first message configures the first bearer and the type of the first RLC bearer is a second type, data units are received via the first RLC bearer in the RRC_Inactive state; data units transmitted via an RLC bearer of the first type are identified by a unicast RNTI, while data units transmitted via an RLC bearer of the second type are identified by a non-unicast RNTI.

According to one aspect of the present application, comprising:
the type of the first RLC bearer is used for updating an RLC bearer that is associated to the first bearer; herein, when the type of the first RLC bearer is the first type, the first RLC bearer is removed from the RLC bearer that is associated to the first bearer; when the type of the first RLC bearer is the second type, the association between the first RLC bearer and the first bearer is maintained.

According to one aspect of the present application, comprising:
the type of the first RLC bearer is used for determining whether to deactivate the first RLC bearer; herein, the first RLC bearer is deactivated only when the type of the first RLC bearer is a former of the first type and the second type.

According to one aspect of the present application, comprising:
receiving a second message, the second message being used for a request for resuming RRC connection; and
transmitting a third message as a response to receiving a second message, the third message indicating that the receiver of the first message enters into RRC_Connected state;
herein, the first RLC bearer is activated; the type of the first RLC bearer is the first type.

According to one aspect of the present application, comprising:
a second RLC bearer that is associated to the first bearer being added when the first bearer is associated only to the first RLC bearer and the first RLC bearer is of the first type before receiving the first message;
herein, data units are received via the second RLC bearer in the RRC_Inactive state; a type of the second RLC bearer is the second type.

According to one aspect of the present application, comprising:
a physical downlink control channel addressed to the unicast RNTI being not monitored by the receiver of the first message in the RRC_Inactive state; herein, data units transmitted via an RLC bearer of the first type are scheduled by a physical downlink control channel addressed to the unicast RNTI.

According to one aspect of the present application, comprising:
the bearer of the first type includes a multicast MRB.

The present application provides a second node for wireless communications, comprising:
a second transmitter, transmitting a first message, the first message indicating an entry into RRC_Inactive state;
herein, whether the receiver of the first message receives data units via a first RLC bearer in the RRC_Inactive state is related to whether the first message configures a first bearer and a type of the first RLC bearer; before receiving the first message the first RLC bearer is associated to the first bearer; when the first message does not configure the first bearer, data units are not received via the first RLC bearer in the RRC_Inactive state; when the first message configures the first bearer and the type of the first RLC bearer is a first type, data units are not received via the first RLC bearer in the RRC_Inactive state; when the first message configures the first bearer and the type of the first RLC bearer is a second type, data units are received via the first RLC bearer in the RRC_Inactive state; data units transmitted via an RLC bearer of the first type are identified by a unicast RNTI, while data units transmitted via an RLC bearer of the second type are identified by a non-unicast RNTI.

### BRIEF DESCRIPTION OF THE DRAWINGS

Other features, objects and advantages of the present application will become more apparent from the detailed description of non-restrictive embodiments taken in conjunction with the following drawings:

FIG. 1 illustrates a flowchart of transmission of a first node according to one embodiment of the present application.

FIG. 2 illustrates a schematic diagram of a network architecture according to one embodiment of the present application.

FIG. 3 illustrates a schematic diagram of a radio protocol architecture of a user plane and a control plane according to one embodiment of the present application.

FIG. 4 illustrates a schematic diagram of hardcore modules in a communication device according to one embodiment of the present application.

FIG. 5 illustrates a first flowchart of a radio signal transmission according to one embodiment of the present application.

FIG. 6 illustrates a second flowchart of a radio signal transmission according to one embodiment of the present application.

FIG. 7 illustrates a third flowchart of a radio signal transmission according to one embodiment of the present application.

FIG. 8 illustrates a fourth flowchart of a radio signal transmission according to one embodiment of the present application.

FIG. 9 illustrates a schematic diagram of a first bearer and an RLC bearer that is associated to the first bearer according to one embodiment of the present application.

FIG. 10 illustrates a structure block diagram of a processing device in a first node according to one embodiment of the present application.

FIG. 11 illustrates a structure block diagram of a processing device in a second node according to one embodiment of the present application.

### DESCRIPTION OF THE EMBODIMENTS

The technical scheme of the present application is described below in further details in conjunction with the drawings. It should be noted that the embodiments of the present application and the characteristics of the embodiments may be arbitrarily combined if no conflict is caused.

### Embodiment 1

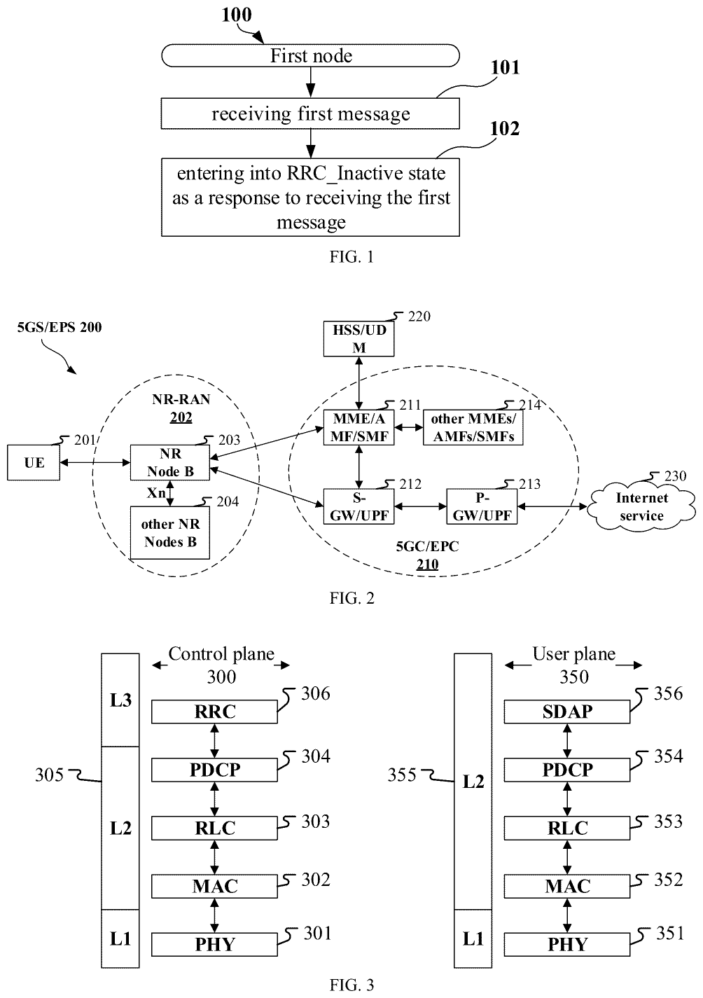

Embodiment 1 illustrates a flowchart of transmission of a first node according to one embodiment of the present application, as shown in FIG. 1.

In Embodiment 1, the first node 100 receives a first message in step 101; and enters into RRC_Inactive state in step 102 as a response to receiving the first message; herein, whether to receive data units via a first RLC bearer in the RRC_Inactive state is related to whether the first message configures a first bearer and a type of the first RLC bearer, before receiving the first message the first RLC bearer is associated to the first bearer; when the first message does not configure the first bearer, data units are not received via the first RLC bearer in the RRC_Inactive state; when the first message configures the first bearer and the type of the first RLC bearer is a first type, data units are not received via the first RLC bearer in the RRC_Inactive state; when the first message configures the first bearer and the type of the first RLC bearer is a second type, data units are received via the first RLC bearer in the RRC_Inactive state; data units transmitted via an RLC bearer of the first type are identified by a unicast RNTI, while data units transmitted via an RLC bearer of the second type are identified by a non-unicast RNTI.

In one embodiment, the first message is received via an air interface.

In one embodiment, the air interface is an NR air interface.

In one embodiment, the air interface is a Uu air interface.

In one embodiment, the first message is an upper-layer message.

In one embodiment, the first message is an RRC layer message.

In one embodiment, the first message is a RRCRelease.

In one embodiment, the first message is used for suspending an RRC connection;

In one embodiment, the first message comprises a suspendConfig field.

In one embodiment, the first message is a RRCRelease including suspendConfig.

In one embodiment, the first message indicates at least one bearer.

In one embodiment, the at least one bearer includes a first bearer.

In one embodiment, the at least one bearer includes a MBMS point to multipoint Radio Bearer (MRB).

In one embodiment, the at least one bearer includes a multicast MRB.

In one embodiment, the at least one bearer includes a Data Radio Bearer (DRB).

In one embodiment, the at least one bearer includes a Signaling Radio Bearer (SRB).

In one embodiment, the at least one bearer is used for transmission of data units in the RRC_Inactive state.

In one subembodiment, the transmission includes at least one of sending or receiving.

In one embodiment, the data unit comprises a Packet Data Convergence Protocol (PDCP) Service Data Unit (SDU).

In one embodiment, the data unit comprises a PDCP control Protocol Data Unit (PDU).

In one embodiment, the data unit comprises a PDCP data PDU.

In one embodiment, the data unit comprises an RLC SDU.

In one embodiment, the data unit comprises an RLC SDU segment.

In one embodiment, the data unit comprises an RLC data PDU.

In one embodiment, the data unit comprises an RLC control PDU.

In one embodiment, one of the data units comprises at least one bit.

In one embodiment, one of the data units comprises at least one byte.

In one embodiment, entering into RRC_Inactive state as a response to receiving the first message; where the first node is in RRC_Connected state prior to receiving the first message.

In one embodiment, the first message is transmitted as indicated by an upper layer of the second node.

In one embodiment, as a response to receiving the first message, it is indicated to the upper layer that an RRC connection is suspended.

In one embodiment, the first message is used to maintain or change the bearer type of the first bearer.

In one embodiment, the first message is used to maintain or reconfigure the first bearer.

In one embodiment, the first bearer is maintained before receiving the first message.

In one embodiment, the first bearer is in an active state before receiving the first message.

In one embodiment, prior to receiving the first message, the first RLC bearer is associated to the first bearer and data units belonging to the first bearer are transmitted via the first RLC bearer.

In one embodiment, the first RLC bearer is associated to the first bearer when the configuration of the first RLC bearer is a lower layer part of the configuration of the first bearer.

In one embodiment, the first RLC bearer is associated to the first bearer when the configuration of the first RLC bearer comprises a configuration of the RLC and logical channel of the first bearer.

In one embodiment, the first RLC bearer is associated to the first bearer when a configuration message of the first RLC bearer includes a first bearer identity.

In one embodiment, the first bearer identity is used to identify the first bearer.

In one embodiment, the first bearer identity is an MRB-Identity.

In one embodiment, the first RLC bearer is associated to the first bearer when a servedMBS-RadioBearer field included in a configuration message of the first RLC bearer indicates the first bearer identity.

In one embodiment, the first RLC bearer is associated to the first bearer when data units belonging to the first bearer are transmitted via the first RLC bearer.

In one embodiment, the first RLC bearer is associated to the first bearer when a first PDCP entity corresponding to the first bearer is associated to a first RLC entity corresponding to the first RLC bearer.

In one embodiment, the first RLC bearer is associated to the first bearer when a first logical channel identified by the first Logical Channel Identity (LCID) is associated to a PDCP entity corresponding to the first bearer.

In one embodiment, the first LCID is used to identify the first RLC bearer.

In one embodiment, whether to receive data units via a first RLC bearer in the RRC_Inactive state is related to whether the first message configures a first bearer and to the type of the first RLC bearer.

In one embodiment, the phrase that the first message does not configure the first bearer comprises: the first message not including the first bearer identity.

In one embodiment, when the first message is used to suspend the first bearer, the first message does not configure the first bearer.

In one embodiment, when the first message is used to release the first bearer, the first message does not configure the first bearer.

In one embodiment, when the first message is used to deactivate the first bearer, the first message does not configure the first bearer.

In one embodiment, data units are not received via the first RLC bearer while in the RRC_Inactive state, when the first message does not configure the first bearer.

In one embodiment, any data unit received by the first node while in the RRC_Inactive state is not identified by the first LCID, when the first message does not configure the first bearer.

In one embodiment, when the first message does not configure the first bearer, the first node in the RRC_Inactive state does not monitor the scheduling signaling that is addressed to the non-unicast Radio Network Temporary Identifier (non-unicast RNTI); where the first bearer is associated to the RLC bearer of the second type.

In one embodiment, the phrase that the first message configures the first bearer comprises: the first message including the first bearer identity.

In one embodiment, the phrase that the first message configures the first bearer comprises: the first message including configuration information for an RLC bearer that is associated to the first bearer.

In one embodiment, when the first message configures the first bearer, the first bearer is not suspended while in the RRC_Inactive state.

In one embodiment, when the first message configures the first bearer, the first bearer is in an active state while in the RRC_Inactive state.

In one embodiment, when the first message configures the first bearer and the type of the first RLC bearer is the first type, data units are not received via the first RLC bearer in the RRC_Inactive state.

In one embodiment, when the first message configures the first bearer and the type of the first RLC bearer is the first type, data units are received via an RLC bearer other than the first RLC bearer in the RRC_Inactive state; where the RLC bearer other than the first RLC bearer is associated to the first bearer, and the RLC bearer other than the first RLC bearer is of the second type.

In one embodiment, when the first message configures the first bearer and the type of the first RLC bearer is the first type, any data unit received while in the RRC_Inactive state is not identified by the first LCID.

In one embodiment, when the first message configures the first bearer and the type of the first RLC bearer is a second type, data units are received via the first RLC bearer in the RRC_Inactive state.

In one embodiment, when one of the data units is identified by the first LCID, the one data unit is considered to be transmitted via the first RLC bearer.

In one embodiment, when a MAC subheader of a MAC (i.e., Medium Access Control) subPDU comprising one data unit includes an LCID, the one data unit is identified by the LCID.

In one embodiment, the RLC bearer of the first type is a Point to Point (PTP) RLC bearer.

In one embodiment, the RLC bearer of the first type is transmitted via PTP.

In one subembodiment, the RLC bearer of the first type is configured with a Downlink only (DL only) RLC-UM (Unacknowledged Mode) entity.

In one subembodiment, the RLC bearer of the first type is configured with a bidirectional RLC-UM entity.

In one subembodiment, the RLC bearer of the first type is configured with an RLC-AM (Acknowledge Mode) entity.

In one embodiment, the RLC bearer of the second type is a Point to Multipoint (PTM) RLC bearer.

In one embodiment, the RLC bearer of the second type is transmitted via PTM.

In one subembodiment, the RLC bearer of the second type is configured with a DL only RLC-UM entity.

In one embodiment, a data unit transmitted via an RLC bearer of the first type is identified by a unicast RNTI and a data unit transmitted via an RLC bearer of the second type is identified by a non-unicast RNTI.

In one embodiment, when one RNTI is used to generate a sequence and the sequence is used to scramble a Physical Downlink Shared Channel (PDSCH) transmitting one data unit, the one data unit being identified by the one RNTI.

In one embodiment, the non-unicast RNTI is a Group-RNTI (G-RNTI).

In one embodiment, the non-unicast RNTI is a Group-Configured Scheduling-RNTI (G-CS-RNTI).

In one embodiment, the unicast RNTI is a Cell-RNTI (C-RNTI).

In one embodiment, the unicast RNTI is a Configured Scheduling-RNTI (CS-RNTI).

In one embodiment, the G-RNTI is used to uniquely identify an MBS session.

In one embodiment, the G-RNTI is used to uniquely identify an MBS session within the second node.

In one embodiment, the G-CS-RNTI is used to uniquely identify an MBS session.

In one embodiment, the G-CS-RNTI is used to uniquely identify an MBS session within the second node.

In one embodiment, the C-RNTI is used to uniquely identify the first node within the second node.

In one embodiment, the CS-RNTI is used to uniquely identify the first node within the second node.

In one embodiment, in the RRC_Inactive state, the first node monitors a control channel associated with a shared data channel to determine whether data units belonging to the first bearer are scheduled.

### Embodiment 2

Embodiment 2 illustrates a schematic diagram of a network architecture according to one embodiment of the present application, as shown in FIG. 2. FIG. 2 illustrates a network architecture 200 of NR 5G, Long-Term Evolution (LTE) and Long-Term Evolution Advanced (LTE-A) systems. The NR 5G or LTE or LTE-A network architecture 200 may be called a 5G System/Evolved Packet System (5GS/EPS) 200 or other suitable terminology. The 5GS/EPS 200 may comprise one or more UEs 201, an NG-RAN 202, a 5G Core Network/Evolved Packet Core (5GC/EPC) 210, a Home Subscriber Server/Unified Data Management (HSS/UDM) 220 and an Internet Service 230. The 5GS/EPS 200 may be interconnected with other access networks. For simple description, the entities/interfaces are not shown. As shown in FIG. 2, the 5GS/EPS 200 provides packet switching services. Those skilled in the art will find it easy to understand that various concepts presented throughout the present application can be extended to networks providing circuit switching services or other cellular networks. The NG-RAN 202 comprises an NR node B (gNB) 203 and other gNBs 204. The gNB 203 provides UE 201 oriented user plane and control plane terminations. The gNB 203 may be connected to other gNBs 204 via an Xn interface (for example, backhaul). The XnAP protocol on the Xn interface is used to transmit control-plane messages for the wireless network, and the user-plane protocol on the Xn interface is used to transmit user-plane data. The gNB 203 may be called a base station, a base transceiver station, a radio base station, a radio transceiver, a transceiver function, a Basic Service Set (BSS), an Extended Service Set (ESS), a Transmission Reception Point (TRP) or some other applicable terms. In NTN, the gNB 203 can be a satellite, an aircraft or a terrestrial base station relayed through the satellite. The gNB 203 provides an access point of the 5GC/EPC 210 for the UE 201. Examples of UE 201 include cellular phones, smart phones, Session Initiation Protocol (SIP) phones, laptop computers, Personal Digital Assistant (PDA), Satellite Radios, Global Positioning Systems (GPSs), multimedia devices, video devices, digital audio players (for example, MP3 players), cameras, games consoles, unmanned aerial vehicles, air vehicles, narrow-band physical network equipment, machine-type communication equipment, land vehicles, automobiles, vehicle-mounted equipment and vehicle-mounted communication units, wearable equipment, or any other devices having similar functions. Those skilled in the art also can call the UE 201 a mobile station, a subscriber station, a mobile unit, a subscriber unit, a wireless unit, a remote unit, a mobile device, a wireless device, a radio communication device, a remote device, a mobile subscriber station, an access terminal, a mobile terminal, a wireless terminal, aremote terminal, a handset, a user proxy, a mobile client, a client or some other appropriate terms. The gNB 203 is connected to the 5GC/EPC 210 via an S1/NG interface. The 5GC/EPC 210 comprises a Mobility Management Entity (MME)/Authentication Management Field (AMF)/Session Management Function (SMF) 211, other MMEs/AMFs/SMFs 214, a Service Gateway (S-GW)/User Plane Function (UPF) 212 and a Packet Date Network Gateway (P-GW)/UPF 213. The MME/AMF/SMF 211 is a control node for processing a signaling between the UE 201 and the 5GC/EPC 210. Generally, the MME/AMF/SMF 211 provides bearer and connection management. All user Internet Protocol (IP) packets are transmitted through the S-GW/UPF 212. The S-GW/UPF 212 is connected to the P-GW/UPF 213. The P-GW 213 provides UE IP address allocation and other functions. The P-GW/UPF 213 is connected to the Internet Service 230. The Internet Service 230 comprises operator-compatible IP services, specifically including Internet, Intranet, IP Multimedia Subsystem (IMS) and Packet Switching (PS) Streaming services.

In one embodiment, the UE 201 corresponds to a first node in the present application.

In one embodiment, the gNB 203 corresponds to a second node in the present application.

In one embodiment, the gNB 203 is a Macro Cell base station.

In one embodiment, the gNB 203 is a Micro Cell base station.

In one embodiment, the gNB 203 is a Pico Cell base station.

In one embodiment, the gNB 203 is a Femtocell.

In one embodiment, the gNB 203 is a base station supporting large time-delay difference.

In one embodiment, the gNB 203 is a flight platform.

In one embodiment, the gNB 203 is satellite equipment.

In one embodiment, a radio link from the UE 201 to the gNB 203 is uplink.

In one embodiment, a radio link from the gNB 203 to the UE 201 is downlink.

In one embodiment, the UE 201 and the gNB 203 are connected by a Uu interface.

### Embodiment 3

Embodiment 3 illustrates a schematic diagram of a radio protocol architecture of a user plane and a control plane according to the present application, as shown in FIG. 3. FIG. 3 is a schematic diagram illustrating an embodiment of a radio protocol architecture of a user plane 350 and a control plane 300. FIG. 3 shows the radio protocol architecture of the control plane 300 of the UE and gNB in three layers: layer 1, layer 2 and layer 3. The layer 1 (L1) is the lowest layer which performs various signal processing functions of PHY layers. The L1 is called PHY 301 in the present application. The layer 2 (L2) 305 is above the PHY 301, and is in charge of the link between the UE and gNB via the PHY 301. The L2 305 comprises a Medium Access Control (MAC) sublayer 302, a Radio Link Control (RLC) sublayer 303 and a Packet Data Convergence Protocol (PDCP) sublayer 304. All these sublayers terminate at the gNB on the network side. The PDCP sublayer 304 provides data encryption and integrity protection, and the PDCP sublayer 304 also provides support for inter-cell mobility of the UE between gNBs. The RLC sublayer 303 provides packet segmentation and reassembly, retransmission of a lost packet via ARQ, and it also provides duplicate packet detection and protocol error detection. The MAC sublayer 302 provides mapping between the logical and transport channels and multiplexing of logical channel IDs. The MAC sublayer 302 is also responsible for allocating between UEs various radio resources (i.e., resource block) in a cell. The MAC sublayer 302 is also responsible for Hybrid Automatic Repeat Request (HARQ) operations. In the control plane 300, The Radio Resource Control (RRC) sublayer 306 in the L3 layer is responsible for acquiring radio resources (i.e., radio bearer) and configuring the lower layer using an RRC signaling between the gNB and the UE. The radio protocol architecture in the user plane 350 comprises the L1 layer and the L2 layer. In the user plane 350, the radio protocol architecture used for a PHY layer 351, a PDCP sublayer 354 of the L2 layer 355, an RLC sublayer 353 of the L2 layer 355 and a MAC sublayer 352 of the L2 layer 355 is almost the same as the radio protocol architecture used for corresponding layers and sublayers in the control plane 300, but the PDCP sublayer 354 also provides header compression used for higher-layer packet to reduce radio transmission overhead. The L2 layer 355 in the user plane 350 also comprises a Service Data Adaptation Protocol (SDAP) sublayer 356, which is in charge of the mapping between Quality of Service (QoS) streams and a Data Radio Bearer (DRB), so as to support diversified traffics. The radio protocol architecture of the UE in the user plane 350 may include some or all of the protocol sublayers of the SDAP sublayer 356, the PDCP sublayer 354, the RLC sublayer 353, and the MAC sublayer 352 at the L2 layer. Although not described in FIG. 3, the UE may comprise several higher layers above the L2 355, such as a network layer (i.e., IP layer) terminated at a P-GW of the network side and an application layer terminated at the other side of the connection (i.e., a peer UE, a server, etc.).

In one embodiment, the radio protocol architecture in FIG. 3 is applicable to a first node in the present application.

In one embodiment, the radio protocol architecture in FIG. 3 is applicable to a second node in the present application.

In one embodiment, entities of multiple sublayers of the control plane in FIG. 3 form a Signaling Radio Bearer (SRB) vertically.

In one embodiment, entities of multiple sublayers of the user plane in FIG. 3 form a Data Radio Bearer (DRB) vertically.

In one embodiment, entities of multiple sublayers of the user plane in FIG. 3 form a MBMS point to multipoint Radio Bearer (MRB) vertically.

In one embodiment, the PDCP sublayer of the control plane in FIG. 3 provides a signaling radio bearer to the RRC sublayer.

In one embodiment, the PDCP sublayer of the user plane in FIG. 3 provides a data radio bearer to the SDAP sublayer.

In one embodiment, the PDCP sublayer of the user plane in FIG. 3 provides a MBMS point to multipoint Radio Bearer (MRB) to the SDAP sublayer.

In one embodiment, the RLC sublayer of the control plane in FIG. 3 provides an RLC bearer to the PDCP sublayer.

In one embodiment, the RLC sublayer in the user plane in FIG. 3 provides an RLC bearer to the PDCP sublayer.

In one embodiment, take transmitting as an example for illustration, the PDCP sublayer receives a packet from an upper layer, generates a PDCP PDU at the PDCP sublayer to be conveyed to the RLC sublayer, generates an RLC PDU at the RLC sublayer to be handed over to the MAC sublayer after adding an RLC subheader, and generates a MAC subPDU at the MAC sublayer after adding a MAC subheader, and one or more MAC subPDUs are multiplexed to generate a MAC PDU to be given to the PHY layer for transmission; where the MAC subheader includes an LCID field, the LCID field indicating an RLC entity corresponding to data included in the MAC subPDU; an RLC entity uniquely corresponds to a PDCP entity; an RLC entity uniquely corresponds to an RLC bearer; a PDCP entity corresponds to a radio bearer.

In one embodiment, a data transfer service is provided between the RLC sublayer and the MAC sublayer over a logical channel.

In one embodiment, a data transfer service is provided between the PDCP sublayer and the RLC sublayer via an RLC channel.

In one embodiment, the first message in the present application is generated by the RRC 306.

In one embodiment, the second message in the present application is generated by the RRC 306.

In one embodiment, the third message in the present application is generated by the RRC 306.

In one embodiment, the data units in the present application are generated by the PDCP 304 and the PDCP 354.

In one embodiment, the data units in the present application are generated by the RLC 303 and the RLC 353.

In one embodiment, the L2 305 belongs to an upper layer.

In one embodiment, the RRC sublayer 306 in the L3 belongs to an upper layer.

### Embodiment 4

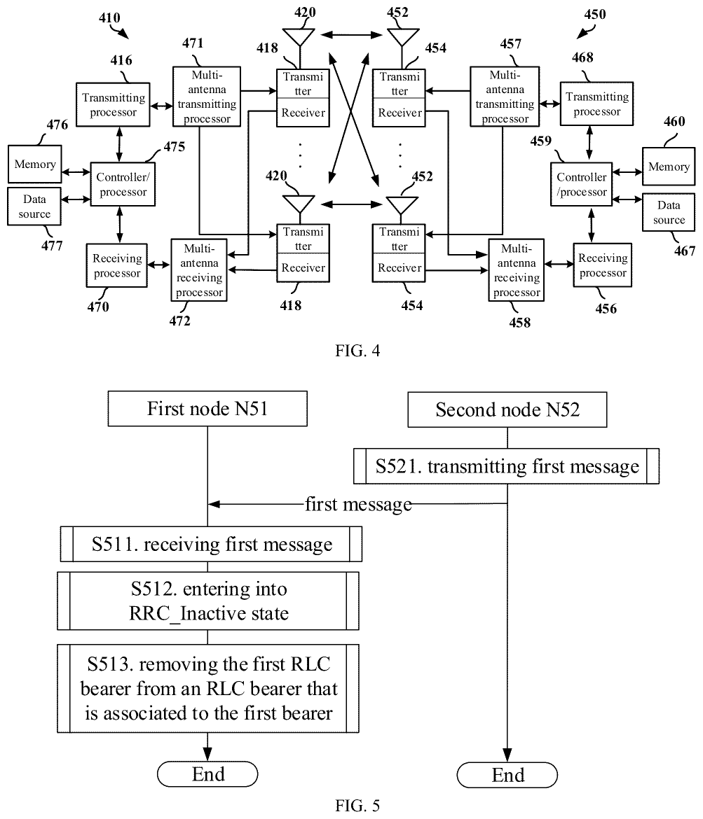

Embodiment 4 illustrates a schematic diagram of hardcore modules in a communication device according to one embodiment of the present application, as shown in FIG. 4. FIG. 4 is a block diagram of a first communication device 450 and a second communication device 410 in communication with each other in an access network.

The first communication device 450 comprises a controller/processor 459, a memory 460, a data source 467, a transmitting processor 468, a receiving processor 456, a multi-antenna transmitting processor 457, a multi-antenna receiving processor 458, a transmitter/receiver 454 and an antenna 452.

The second communication device 410 comprises a controller/processor 475, a memory 476, a data source 477, a receiving processor 470, a transmitting processor 416, a multi-antenna receiving processor 472, a multi-antenna transmitting processor 471, a transmitter/receiver 418 and an antenna 420.

In a transmission from the second communication device 410 to the first communication device 450, at the second communication device 410, a higher layer packet from a core network or from a data source 477 is provided to the controller/processor 475. The core network and data source 477 represents all protocol layers above the L2 layer. The controller/processor 475 provides functions of the L2 layer. In the transmission from the second communication device 410 to the first communication device 450, the controller/processor 475 provides header compression, encryption, packet segmentation and reordering, and multiplexing between a logical channel and a transport channel, and radio resource allocation of the first communication device 450 based on various priorities. The controller/processor 475 is also in charge of a retransmission of a lost packet and a signaling to the first communication device 450. The transmitting processor 416 and the multi-antenna transmitting processor 471 perform various signal processing functions used for the L1 layer (i.e., PHY). The transmitting processor 416 performs coding and interleaving so as to ensure a Forward Error Correction (FEC) at the second communication device 410 side and the mapping of signal clusters corresponding to each modulation scheme (i.e., BPSK, QPSK, M-PSK, and M-QAM, etc.). The multi-antenna transmitting processor 471 performs digital spatial precoding, which includes precoding based on codebook and precoding based on non-codebook, and beamforming processing on encoded and modulated signals to generate one or more spatial streams. The transmitting processor 416 then maps each spatial stream into a subcarrier. The mapped symbols are multiplexed with a reference signal (i.e., pilot frequency) in time domain and/or frequency domain, and then they are assembled through Inverse Fast Fourier Transform (IFFT) to generate a physical channel carrying time-domain multicarrier symbol streams. After that the multi-antenna transmitting processor 471 performs transmission analog precoding/beamforming on the time-domain multicarrier symbol streams. Each transmitter 418 converts a baseband multicarrier symbol stream provided by the multi-antenna transmitting processor 471 into a radio frequency (RF) stream, which is later provided to different antennas 420.

In a transmission from the second communication device 410 to the first communication device 450, at the first communication device 450, each receiver 454 receives a signal via a corresponding antenna 452. Each receiver 454 recovers information modulated to the RF carrier, and converts the radio frequency stream into a baseband multicarrier symbol stream to be provided to the receiving processor 456. The receiving processor 456 and the multi-antenna receiving processor 458 perform signal processing functions of the L1 layer. The multi-antenna receiving processor 458 performs reception analog precoding/beamforming on a baseband multicarrier symbol stream provided by the receiver 454. The receiving processor 456 converts the processed baseband multicarrier symbol stream from time domain into frequency domain using FFT. In frequency domain, a physical layer data signal and a reference signal are de-multiplexed by the receiving processor 456, wherein the reference signal is used for channel estimation, while the data signal is subjected to multi-antenna detection in the multi-antenna receiving processor 458 to recover any first communication device 450-targeted spatial stream. Symbols on each spatial stream are demodulated and recovered in the receiving processor 456 to generate a soft decision. Then the receiving processor 456 decodes and de-interleaves the soft decision to recover the higher-layer data and control signal transmitted by the second communication device 410 on the physical channel. Next, the higher-layer data and control signal are provided to the controller/processor 459. The controller/processor 459 provides functions of the L2 layer. The controller/processor 459 can be associated with the memory 460 that stores program code and data; the memory 460 may be called a computer readable medium. In a transmission from the second communication device 410 to the first communication device 450, the controller/processor 459 provides de-multiplexing between a transport channel and a logical channel, packet reassembling, decrypting, header decompression, control signal processing so as to recover a higher-layer packet from the second communication device 410. The higher-layer packet is later provided to all protocol layers above the L2 layer. Or various control signals can be provided to the L3 for processing.

In a transmission from the first communication device 450 to the second communication device 410, at the first communication device 450, the data source 467 is configured to provide a higher-layer packet to the controller/processor 459. The data source 467 represents all protocol layers above the L2 layer. Similar to a transmitting function of the second communication device 410 described in the transmission from the second communication device 410 to the first communication device 450, the controller/processor 459 performs header compression, encryption, packet segmentation and reordering, and multiplexing between a logical channel and a transport channel so as to provide the L2 layer functions used for the user plane and the control plane. The controller/processor 459 is also responsible for a retransmission of a lost packet, and a signaling to the second communication device 410. The transmitting processor 468 performs modulation and mapping, as well as channel coding, and the multi-antenna transmitting processor 457 performs digital multi-antenna spatial precoding, including precoding based on codebook and precoding based on non-codebook, and beamforming. The transmitting processor 468 then modulates generated spatial streams into multicarrier/single-carrier symbol streams. The modulated symbol streams, after being subjected to analog precoding/beamforming in the multi-antenna transmitting processor 457, are provided from the transmitter 454 to each antenna 452. Each transmitter 454 firstly converts a baseband symbol stream provided by the multi-antenna transmitting processor 457 into a radio frequency symbol stream, and then provides the radio frequency symbol stream to the antenna 452.

In a transmission from the first communication device 450 to the second communication device 410, the function of the second communication device 410 is similar to the receiving function of the first communication device 450 described in the transmission from the second communication device 410 to the first communication device 450. Each receiver 418 receives a radio frequency signal via a corresponding antenna 420, converts the received radio frequency signal into a baseband signal, and provides the baseband signal to the multi-antenna receiving processor 472 and the receiving processor 470. The receiving processor 470 and the multi-antenna receiving processor 472 jointly provide functions of the L1 layer. The controller/processor 475 provides functions of the L2 layer. The controller/processor 475 can be associated with the memory 476 that stores program code and data; the memory 476 may be called a computer readable medium. In the transmission from the first communication device 450 to the second communication device 410, the controller/processor 475 provides de-multiplexing between a transport channel and a logical channel, packet reassembling, decrypting, header decompression, control signal processing so as to recover a higher-layer packet from the first communication device 450. The higher-layer packet coming from the controller/processor 475 may be provided to the core network, or all protocol layers above the L2, or, various control signals can be provided to the core network or L3 for processing.

In one embodiment, the first communication device 450 comprises at least one processor and at least one memory. The at least one memory comprises computer program codes; the at least one memory and the computer program codes are configured to be used in collaboration with the at least one processor. The first communication device 450 at least receives a first message; and enters into RRC_Inactive state as a response to receiving the first message; herein, whether to receive data units via a first RLC bearer in the RRC_Inactive state is related to whether the first message configures a first bearer and a type of the first RLC bearer; before receiving the first message the first RLC bearer is associated to the first bearer; when the first message does not configure the first bearer, data units are not received via the first RLC bearer in the RRC_Inactive state; when the first message configures the first bearer and the type of the first RLC bearer is a first type, data units are not received via the first RLC bearer in the RRC_Inactive state; when the first message configures the first bearer and the type of the first RLC bearer is a second type, data units are received via the first RLC bearer in the RRC_Inactive state; data units transmitted via an RLC bearer of the first type are identified by a unicast RNTI, while data units transmitted via an RLC bearer of the second type are identified by a non-unicast RNTI.

In one embodiment, the first communication device 450 comprises a memory that stores a computer readable instruction program. The computer readable instruction program generates actions when executed by at least one processor. The actions include: receiving a first message; and entering into RRC_Inactive state as a response to receiving the first message; herein, whether to receive data units via a first RLC bearer in the RRC_Inactive state is related to whether the first message configures a first bearer and a type of the first RLC bearer; before receiving the first message the first RLC bearer is associated to the first bearer; when the first message does not configure the first bearer, data units are not received via the first RLC bearer in the RRC_Inactive state; when the first message configures the first bearer and the type of the first RLC bearer is a first type, data units are not received via the first RLC bearer in the RRC_Inactive state; when the first message configures the first bearer and the type of the first RLC bearer is a second type, data units are received via the first RLC bearer in the RRC_Inactive state; data units transmitted via an RLC bearer of the first type are identified by a unicast RNTI, while data units transmitted via an RLC bearer of the second type are identified by a non-unicast RNTI.

In one embodiment, the second communication device 410 comprises at least one processor and at least one memory. The at least one memory comprises computer program codes; the at least one memory and the computer program codes are configured to be used in collaboration with the at least one processor. The first communication device 450 at least transmits a first message, the first message indicating an entry into RRC_Inactive state; herein, whether the receiver of the first message receives data units via a first RLC bearer in the RRC_Inactive state is related to whether the first message configures a first bearer and a type of the first RLC bearer; before receiving the first message the first RLC bearer is associated to the first bearer; when the first message does not configure the first bearer, data units are not received via the first RLC bearer in the RRC_Inactive state; when the first message configures the first bearer and the type of the first RLC bearer is a first type, data units are not received via the first RLC bearer in the RRC_Inactive state; when the first message configures the first bearer and the type of the first RLC bearer is a second type, data units are received via the first RLC bearer in the RRC_Inactive state; data units transmitted via an RLC bearer of the first type are identified by a unicast RNTI, while data units transmitted via an RLC bearer of the second type are identified by a non-unicast RNTI.

In one embodiment, the second communication device 410 comprises a memory that stores a computer readable instruction program. The computer readable instruction program generates actions when executed by at least one processor. The actions include: transmitting a first message, the first message indicating an entry into RRC_Inactive state; herein, whether the receiver of the first message receives data units via a first RLC bearer in the RRC_Inactive state is related to whether the first message configures a first bearer and a type of the first RLC bearer; before receiving the first message the first RLC bearer is associated to the first bearer; when the first message does not configure the first bearer, data units are not received via the first RLC bearer in the RRC_Inactive state; when the first message configures the first bearer and the type of the first RLC bearer is a first type, data units are not received via the first RLC bearer in the RRC_Inactive state; when the first message configures the first bearer and the type of the first RLC bearer is a second type, data units are received via the first RLC bearer in the RRC_Inactive state; data units transmitted via an RLC bearer of the first type are identified by a unicast RNTI, while data units transmitted via an RLC bearer of the second type are identified by a non-unicast RNTI.

In one embodiment, the first communication device 450 corresponds to the first node in the present application.

In one embodiment, the second communication device 410 corresponds to the second node in the present application.

In one embodiment, the first communication device 450 is a UE.

In one embodiment, the second communication device 410 is a base station.

In one embodiment, at least one of the antenna 420, the transmitter 418, the multi-antenna transmitting processor 471, the transmitting processor 416 or the controller/processor 475 is used for transmitting a first message in the present application.

In one embodiment, at least one of the antenna 452, the receiver 454, the multi-antenna receiving processor 458, the receiving processor 456 or the controller/processor 459 is used for receiving a first message in the present application.

In one embodiment, at least one of the antenna 452, the transmitter 454, the multi-antenna transmitting processor 457, the transmitting processor 468 or the controller/processor 459 is used for transmitting a second message in the present application.

In one embodiment, at least one of the antenna 420, the receiver 418, the multi-antenna receiving processor 472, the receiving processor 470 or the controller/processor 475 is used for receiving a second message in the present application.

In one embodiment, at least one of the antenna 420, the transmitter 418, the multi-antenna transmitting processor 471, the transmitting processor 416 or the controller/processor 475 is used for transmitting a third message in the present application.

In one embodiment, at least one of the antenna 452, the receiver 454, the multi-antenna receiving processor 458, the receiving processor 456 or the controller/processor 459 is used for receiving a third message in the present application.

In one embodiment, at least one of the antenna 420, the transmitter 418, the multi-antenna transmitting processor 471, the transmitting processor 416 or the controller/processor 475 is used for transmitting data units in the present application.

In one embodiment, at least one of the antenna 452, the receiver 454, the multi-antenna receiving processor 458, the receiving processor 456 or the controller/processor 459 is used for receiving data units in the present application.

### Embodiment 5

Embodiment 5 illustrates a first flowchart of a radio signal transmission according to one embodiment of the present application, as shown in FIG. 5. A first node N51 and a second node N52 are in communication via an air interface. It should be particularly noted that the sequence illustrated herein does not set any limit to the signal transmission order or implementation order in the present application.

The first node N51 receives a first message in step S511; enters RRC_Inactive state in step S512; and removes the first RLC bearer from an RLC bearer that is associated to the first bearer in step S513.

The second node N52 transmits a first message in step S521.

In Embodiment 5, receiving a first message; and entering into RRC_Inactive state as a response to receiving the first message; herein, whether to receive data units via a first RLC bearer in the RRC_Inactive state is related to whether the first message configures a first bearer and a type of the first RLC bearer, before receiving the first message the first RLC bearer is associated to the first bearer; when the first message does not configure the first bearer, data units are not received via the first RLC bearer in the RRC_Inactive state; when the first message configures the first bearer and the type of the first RLC bearer is a first type, data units are not received via the first RLC bearer in the RRC_Inactive state; when the first message configures the first bearer and the type of the first RLC bearer is a second type, data units are received via the first RLC bearer in the RRC_Inactive state; data units transmitted via an RLC bearer of the first type are identified by a unicast RNTI, while data units transmitted via an RLC bearer of the second type are identified by a non-unicast RNTI; updating an RLC bearer that is associated to the first bearer according to the type of the first RLC bearer as a response to receiving the first message; herein, when the type of the first RLC bearer is the first type, removing the first RLC bearer from the RLC bearer that is associated to the first bearer; stopping monitoring of a physical downlink control channel addressed to the unicast RNTI in the RRC_Inactive state; herein, data units transmitted via an RLC bearer of the first type are scheduled by a physical downlink control channel addressed to the unicast RNTI; the first bearer is a multicast MRB.

In Embodiment 5, prior to receiving the first message, the first bearer is not only associated to the first RLC bearer of the first type, but also associated to at least one RLC bearer of the second type.

It is to be noted that although not shown in the figure, after step S513, the first node receives data units from the second node via one RLC bearer of the second type associated to the first bearer.

In one embodiment, the second node is a base station of a serving cell of the first node.

In one embodiment, the second node is a base station of a primary cell (PCell) of the first node.

In one embodiment, the second node is a base station for a Secondary cell (SCell) of the first node.

In one embodiment, an RLC bearer that is associated to the first bearer is updated according to the type of the first RLC bearer as a response to receiving the first message.

Typically, the first message comprises a field for configuring or releasing the RLC bearer.

In one embodiment, the field for configuring or releasing an RLC bearer is named rlc-BearerToReleaseList.

In one embodiment, when the type of the first RLC bearer is the first type, the first RLC bearer is removed from the RLC bearer that is associated to the first bearer.

In one embodiment, when the type of the first RLC bearer is the first type, a field included in the first information for configuring or releasing an RLC bearer includes the first LCID.

In one embodiment, the phrase that the first RLC bearer is removed from the RLC bearer that is associated to the first bearer comprises: releasing the first RLC entity.

In one embodiment, the phrase that the first RLC bearer is removed from the RLC bearer that is associated to the first bearer comprises: discarding all RLC SDU(s), RLC SDU segment(s) and RLC PDU(s) in the first RLC entity.

In one embodiment, the phrase that the first RLC bearer is removed from the RLC bearer that is associated to the first bearer comprises: releasing a logical channel corresponding to the first RLC bearer.

In one embodiment, upon removal of the first RLC bearer from the RLC bearer that is associated to the first bearer, data units transmitted via the first bearer are no longer transmitted via the first RLC bearer.

In one embodiment, upon removal of the first RLC bearer from the RLC bearer that is associated to the first bearer, data units transmitted via the first bearer are no longer indicated by the first LCID.

In one embodiment, the first transmitter, after receiving the first message and before removing the first RLC bearer from the RLC bearer that is associated to the first bearer, transmits a first RLC control signaling via the first RLC bearer; where the first RLC control signaling is generated and has not completed its transmission before receiving the first message, the type of the first RLC bearer is the first type and the first RLC entity is configured to be in Acknowledged Mode (AM).

In one embodiment, monitoring of a Physical Downlink Control Channel (PDCCH) addressed to the unicast RNTI is stopped while in the RRC_Inactive state.

In one embodiment, data units transmitted via an RLC bearer of the first type are scheduled by a physical downlink control channel addressed to the unicast RNTI.

In one embodiment, the phrase stopping monitoring of a physical downlink control channel addressed to the unicast RNTI comprises: monitoring a physical downlink control channel addressed to the non-unicast RNTI.

In one embodiment, the phrase stopping monitoring of a physical downlink control channel addressed to the unicast RNTI comprises: monitoring a physical downlink control channel addressed to a Paging-RNTI (P-RNTI).

In one embodiment, the phrase stopping monitoring of a physical downlink control channel addressed to the unicast RNTI comprises: monitoring a physical downlink control channel addressed to a System Information-RNTI (SI-RNTI).

In one embodiment, the phrase stopping monitoring of a physical downlink control channel addressed to the unicast RNTI comprises: monitoring a physical downlink control channel addressed to a Random Access-RNTI (RA-RNTI).

In one embodiment, the phrase stopping monitoring of a physical downlink control channel addressed to the unicast RNTI comprises: monitoring a physical downlink control channel addressed to a MBS Control Channel-RNTI (MCCH-RNTI).

In one embodiment, the phrase of a physical downlink control channel addressed to the unicast RNTI comprises: the physical downlink control channel being identified by the unicast RNTI.

In one embodiment, the phrase of a physical downlink control channel addressed to the unicast RNTI comprises: the physical downlink control channel comprising a piece of Downlink Control Information (i.e., a DCI) with Cyclic Redundancy Check (CRC) scrambled by the unicast RNTI.

In one embodiment, the phrase of a physical downlink control channel addressed to the unicast RNTI comprises: the physical downlink control channel being scrambled by the unicast RNTI.

In one embodiment, while in the RRC_Inactive state the first node monitors a physical downlink control channel addressed to the non-unicast RNTI; herein, data units transmitted via an RLC bearer of the second type are scheduled by a physical downlink control channel addressed to the non-unicast RNTI.

In one embodiment, a PDSCH is scheduled by a physical downlink control channel addressed to the non-unicast RNTI, the PDSCH comprising data units transmitted via the RLC bearer of the second type.

In one embodiment, the meaning of the monitoring includes to search.

In one embodiment, the meaning of the monitoring includes to monitor.

In one embodiment, the meaning of the monitoring includes energy detection.

In one embodiment, the meaning of the monitoring includes coherent detection.

In one embodiment, the meaning of the monitoring includes blind decoding detection.

In one embodiment, the first bearer is a multicast MRB.

In one embodiment, the multicast MRB is used for MBS transmission.

In one embodiment, the bearer type of the multicast MRB is one of PTM-only MRB, PTP-only MRB or split MRB.

### Embodiment 6

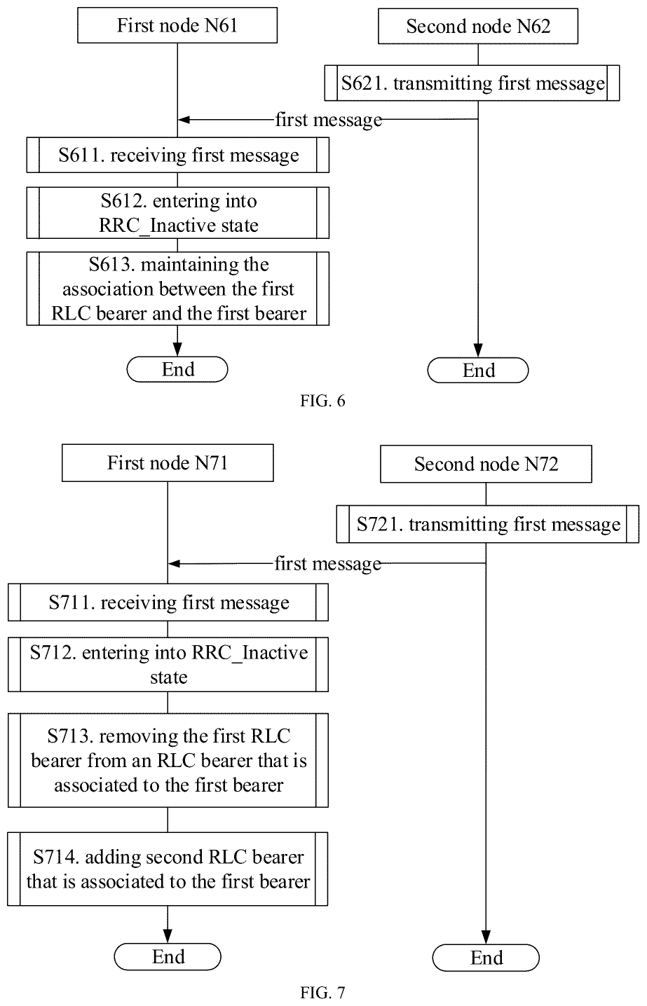

Embodiment 6 illustrates a second flowchart of a radio signal transmission according to one embodiment of the present application, as shown in FIG. 6. A first node N61 and a second node N62 are in communication via an air interface. It should be particularly noted that the sequence illustrated herein does not set any limit to the signal transmission order or implementation order in the present application.

The first node N61 receives a first message in step S611; enters RRC_Inactive state in step S612; and maintains the association between the first RLC bearer and the first bearer in step S613.

The second node N62 transmits a first message in step S621.

In Embodiment 6, receiving a first message; entering into RRC_Inactive state as a response to receiving the first message; and updating an RLC bearer that is associated to the first bearer according to the type of the first RLC bearer as a response to receiving the first message; herein, when the type of the first RLC bearer is the second type, maintaining the association between the first RLC bearer and the first bearer.

It is to be noted that although not shown in the figure, after step S613, the first node receives data units from the second node via the first RLC bearer that is associated to the first bearer.

In one embodiment, an RLC bearer that is associated to the first bearer is updated according to the type of the first RLC bearer as a response to receiving the first message.

In one embodiment, when the type of the first RLC bearer is the second type, the association between the first RLC bearer and the first bearer is maintained.

In one embodiment, when the type of the first RLC bearer is the second type, a field included in the first information for configuring or releasing an RLC bearer does not include the first LCID.

In one embodiment, when the type of the first RLC bearer is the second type, the first information does not include the first LCID.

In one embodiment, the phrase maintaining the association between the first RLC bearer and the first bearer comprises: maintaining the first RLC entity.

In one embodiment, the phrase maintaining the association between the first RLC bearer and the first bearer comprises: maintaining a logical channel corresponding to the first RLC bearer.

### Embodiment 7

Embodiment 7 illustrates a third flowchart of radio signal transmission according to one embodiment of the present application, as shown in FIG. 7. A first node N71 and a second node N72 are in communication via an air interface. It should be particularly noted that the sequence illustrated herein does not set any limit to the signal transmission order or implementation order in the present application.

The first node N71 receives a first message in step S711; enters RRC_Inactive state in step S712; and removes the first RLC bearer from an RLC bearer that is associated to the first bearer in step S713; and adds a second RLC bearer that is associated to the first bearer in step S714.

The second node N72 transmits a first message in step S721.

In Embodiment 7, receiving a first message; entering into RRC_Inactive state as a response to receiving the first message; and updating an RLC bearer that is associated to the first bearer according to the type of the first RLC bearer as a response to receiving the first message; herein, when the type of the first RLC bearer is the first type, the first RLC bearer is removed from the RLC bearer that is associated to the first bearer; as a response to receiving the first message, a second RLC bearer that is associated to the first bearer is added when the first bearer is associated only to the first RLC bearer and the first RLC bearer is of the first type before receiving the first message; herein, data units are received via the second RLC bearer in the RRC_Inactive state; a type of the second RLC bearer is the second type.

In Embodiment 7, prior to receiving the first message, the first bearer is associated only to the first RLC bearer and the first RLC bearer is of the first type.

It is to be noted that although not shown in the figure, after step S714, the first node receives data units from the second node via the second RLC bearer that is associated to the first bearer.

In one embodiment, as a response to receiving the first message, adding a second RLC bearer that is associated to the first bearer when the first bearer is associated only to the first RLC bearer and the first RLC bearer is of the first type before receiving the first message.

In one embodiment, before receiving the first message the first bearer is not associated to any RLC bearer other than the first RLC bearer.

In one embodiment, the number of RLC bearer(s) associated to the first bearer prior to receiving the first message is 1.

Typically, the first message comprises a field for configuring or adding or modifying an RLC bearer.

In one embodiment, the field for configuring or adding or modifying an RLC bearer is named rlc-BearerToAddModList.

In one embodiment, when the first bearer is associated only to the first RLC bearer and the first RLC bearer is of the first type before receiving the first message, adding the second RLC bearer and associating the second RLC bearer to the first bearer.

In one embodiment, when the first bearer is associated only to the first RLC bearer and the first RLC bearer is of the first type before receiving the first message, the first message includes a second LCID.

In one embodiment, the second LCID is used to identify the second RLC bearer.

In one embodiment, when the first bearer is associated only to the first RLC bearer and the first RLC bearer is of the first type before receiving the first message, the first message includes configuration information for the second RLC bearer.

In one embodiment, when the first bearer is associated only to the first RLC bearer and the first RLC bearer is of the first type before receiving the first message, the first message includes configuration information for the second RLC bearer; the configuration information for the second RLC bearer includes the first bearer identity.

In one embodiment, the phrase adding the second RLC bearer comprises: establishing a second RLC entity, the second RLC entity corresponding to the second RLC bearer.

In one embodiment, the phrase adding the second RLC bearer comprises: establishing a second logical channel, the second logical channel corresponding to the second RLC bearer.

In one embodiment, the phrase adding the second RLC bearer and associating the second RLC bearer to the first bearer comprises: associating a second logical channel identified by the second LCID with a PDCP entity corresponding to the first bearer.

In one embodiment, the type of the second RLC bearer is the second type.

In one embodiment, the second RLC bearer is a PTM RLC bearer.

In one embodiment, the first transmitter, after receiving the first message and before deactivating the first RLC bearer, transmits a first RLC control signaling via the first RLC bearer; where the first RLC control signaling is generated and has not completed its transmission before receiving the first message, the type of the first RLC bearer is the first type and the first RLC entity is configured to be in Acknowledged Mode (AM).

In one embodiment, the second RLC bearer is used for reception of data units in the RRC_Inactive state.

In one embodiment, the second RLC bearer is active in the RRC_Inactive state.

In one embodiment, the second RLC bearer is used for reception of data units belonging to the first bearer while in the RRC_Inactive state.

### Embodiment 8

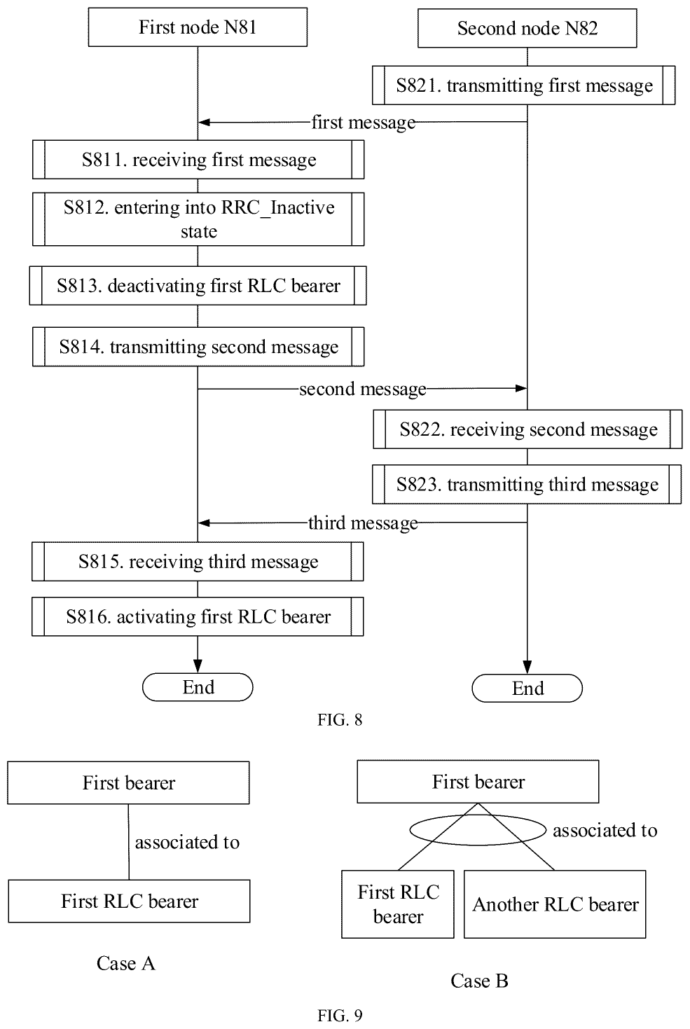

Embodiment 8 illustrates a fourth flowchart of a radio signal transmission according to one embodiment of the present application, as shown in FIG. 8. A first node N81 and a second node N82 are in communication via an air interface. It should be particularly noted that the sequence illustrated herein does not set any limit to the signal transmission order or implementation order in the present application.

The first node N81 receives a first message in step S811; enters RRC_Inactive state in step S812; and deactivates a first RLC bearer in step S813; and transmits a second message in step S814; receives a third message in step S815; and activates a first RLC bearer in step S816.

The second node N82 transmits a first message in step S821; receives a second message in step S822; and transmits a third message in step S823.

In Embodiment 8, receiving a first message; and entering into RRC_Inactive state as a response to receiving the first message; and determining whether to deactivate the first RLC bearer according to the type of the first RLC bearer as a response to receiving the first message; herein, the first RLC bearer is deactivated only when the type of the first RLC bearer is a former of the first type and the second type; transmitting a second message, the second message being used for a request for resuming RRC connection; and a third message is received as a response to transmitting a second message, the third message indicating that the first node enters into RRC_Connected state; and the first RLC bearer is activated as a response to receiving a third message; herein, the type of the first RLC bearer is the first type.

In Embodiment 8, prior to receiving the first message, the first bearer is not only associated to the first RLC bearer of the first type, but also associated to at least one RLC bearer of the second type.

It is to be noted that although not shown in the figure, after step S813 and before step S814, the first node receives data units from the second node via one RLC bearer of the second type associated to the first bearer.

In one embodiment, determining whether to deactivate the first RLC bearer according to the type of the first RLC bearer as a response to receiving the first message.

Typically, the first message comprises no field for releasing the RLC bearer.

In one embodiment, the first message does not include a field for configuring an RLC bearer and does not include a field for releasing an RLC bearer.

In one embodiment, the first RLC bearer is deactivated only when the type of the first RLC bearer is a former of the first type and the second type.

In one embodiment, the phrase of deactivating the first RLC bearer comprises: suspending the first RLC bearer.

In one embodiment, the phrase of deactivating the first RLC bearer comprises: disabling the transmission of data units via the first RLC bearer.

In one embodiment, maintaining the first RLC bearer when the type of the first RLC bearer is the second type.

In one embodiment, as a response to receiving the first message, indicating to a lower layer de-activation of the first RLC bearer; where the type of the first RLC bearer is the first type.

In one embodiment, as a response to receiving the first message, the RRC sublayer of the first node indicates to the RLC sublayer of the first node de-activation of the first RLC bearer; where the type of the first RLC bearer is the first type.

In one embodiment, as a response to receiving the first message, the RRC sublayer of the first node indicates to the PDCP sublayer of the first node de-activation of the first RLC bearer; where the type of the first RLC bearer is the first type.

In one embodiment, the first RLC entity is re-established when deactivating the first RLC bearer.

In one embodiment, all RLC SDU(s), RLC SDU segment(s) and RLC PDU(s) in the first RLC entity are discarded when deactivating the first RLC bearer.

In one embodiment, the first RLC entity is not released when deactivating the first RLC bearer.

In one embodiment, a logical channel corresponding to the first RLC bearer is not released when deactivating the first RLC bearer.

In one embodiment, receiving data units via the first RLC bearer is stopped after deactivating the first RLC bearer.

In one embodiment, the second message is a higher-layer message.

In one embodiment, the second message is an RRC message.

In one embodiment, the second message is used to request a transition of RRC state.

In one embodiment, the second message is used to request resuming of an RRC connection.

In one embodiment, the second message is used to request an entry into RRC_Connected state.

In one embodiment, the second message is a RRCResumeRequest message.

In one embodiment, the second message is a RRCResumeRequest1 message.

In one embodiment, the second message comprises the reason for triggering the second message.

In one embodiment, receiving a third message as a response to transmitting the second message, the third message indicating that the first node enters into RRC_Connected state.

In one embodiment, the third message is a higher-layer message.

In one embodiment, the third message is an RRC message.

In one embodiment, the third message is RRCResume.

In one embodiment, the third message is used for resuming an RRC connection.

In one embodiment, after receiving the third message, suspended SRB(s) and DRB(s) are resumed.

In one embodiment, after receiving the third message, suspended RLC bearers are resumed.

In one embodiment, after receiving the third message, an indication is given to the upper layer that suspended RRC connection has been resumed.

In one embodiment, activating the first RLC bearer as a response to receiving the third message.

In one embodiment, the phrase of activating the first RLC bearer comprises: resuming the first RLC bearer.

In one embodiment, the phrase of activating the first RLC bearer comprises: enabling the transmission of data units via the first RLC bearer.

Typically, the third message does not comprise a field for configuring or adding or modifying an RLC bearer.

In one embodiment, the first message does not include a field for configuring an RLC bearer and does not include a field for adding an RLC bearer.

In one embodiment, as a response to receiving the third message, indicating to a lower layer activation of the first RLC bearer; where the type of the first RLC bearer is the first type.

In one embodiment, as a response to receiving the third message, the RRC sublayer of the first node indicates to the RLC sublayer of the first node activation of the first RLC bearer; where the type of the first RLC bearer is the first type.

In one embodiment, as a response to receiving the third message, the RRC sublayer of the first node indicates to the PDCP sublayer of the first node activation of the first RLC bearer; where the type of the first RLC bearer is the first type.

In one embodiment, data units are transmitted via the first RLC bearer after activating the first RLC bearer.

In one embodiment, the first receiver receives a third message as a response to transmitting a second message, the third message indicating that the first node enters into RRC_Connected state; the third message comprising a field for configuring an RLC bearer of the first type.

### Embodiment 9

Embodiment 9 illustrates a schematic diagram of a first bearer and an RLC bearer that is associated to the first bearer according to one embodiment of the present application, as shown in FIG. 9.

In one embodiment, the first bearer is associated only with the first RLC bearer.

In one subembodiment of the embodiment, the first RLC bearer is an RLC bearer of the first type.

In one subembodiment of the embodiment, the first RLC bearer is an RLC bearer of the second type.

In one embodiment, the first bearer is associated to both the first RLC bearer and another RLC bearer.

In one subembodiment of the embodiment, the first RLC bearer is an RLC bearer of the first type; the other RLC bearer is an RLC bearer of the second type.

In one subembodiment of the embodiment, the first RLC bearer is an RLC bearer of the second type; the other RLC bearer is an RLC bearer of the first type.

In Case A of Embodiment 9, the first bearer is associated only to the first RLC bearer; in Case B of Embodiment 9, the first bearer is associated to both the first RLC bearer and another RLC bearer.

In one embodiment, when the first bearer is associated only to the first RLC bearer and the first RLC bearer is of the first type, the first bearer is a multicast PTP-only MRB.

In one embodiment, when the first bearer is associated only to the first RLC bearer only and the first RLC bearer is of the second type, the first bearer is a multicast PTM-only MRB.

In one embodiment, when the first bearer is associated to both an RLC bearer of the first type and an RLC bearer of the second type, the first bearer is a multicast split MRB.

### Embodiment 10

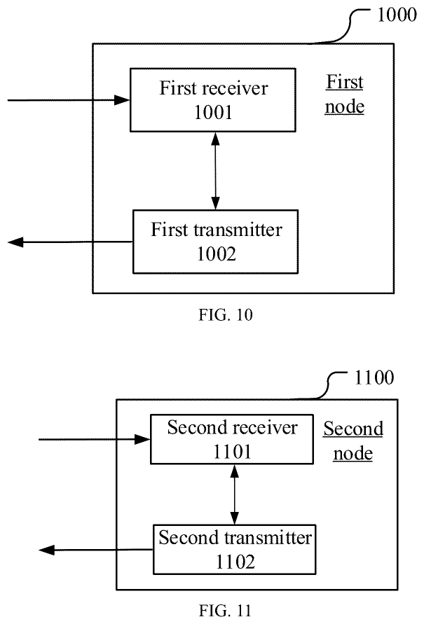

Embodiment 10 illustrates a structure block diagram of a processing device in a first node according to one embodiment of the present application, as shown in FIG. 10. In FIG. 10, a processing device in a first node 1000 is comprised of a first receiver 1001 and a first transmitter 1002; the first node 1000 is a UE.

In Embodiment 10, the first receiver 1001 receives a first message; and enters into RRC_Inactive state as a response to receiving the first message; herein, whether to receive data units via a first RLC bearer in the RRC_Inactive state is related to whether the first message configures a first bearer and a type of the first RLC bearer; before receiving the first message the first RLC bearer is associated to the first bearer; when the first message does not configure the first bearer, data units are not received via the first RLC bearer in the RRC_Inactive state; when the first message configures the first bearer and the type of the first RLC bearer is a first type, data units are not received via the first RLC bearer in the RRC_Inactive state; when the first message configures the first bearer and the type of the first RLC bearer is a second type, data units are received via the first RLC bearer in the RRC_Inactive state; data units transmitted via an RLC bearer of the first type are identified by a unicast RNTI, while data units transmitted via an RLC bearer of the second type are identified by a non-unicast RNTI.

In one embodiment, the first receiver 1001 updates an RLC bearer that is associated to the first bearer according to the type of the first RLC bearer as a response to receiving the first message; herein, when the type of the first RLC bearer is the first type, the first RLC bearer is removed from the RLC bearer that is associated to the first bearer; when the type of the first RLC bearer is the second type, the association between the first RLC bearer and the first bearer is maintained.

In one embodiment, the first receiver 1001 determines whether to deactivate the first RLC bearer according to the type of the first RLC bearer as a response to receiving the first message; herein, the first RLC bearer is deactivated only when the type of the first RLC bearer is a former of the first type and the second type.

In one embodiment, the first transmitter 1002 transmits a second message, the second message being used for a request for resuming RRC connection; and the first receiver 1001 receives a third message as a response to transmitting a second message, the third message indicating that the first node enters into RRC_Connected state; and activates the first RLC bearer as a response to receiving a third message; herein, the type of the first RLC bearer is the first type.

In one embodiment, the first receiver 1001, as a response to receiving the first message, adds a second RLC bearer that is associated to the first bearer when the first bearer is associated only to the first RLC bearer and the first RLC bearer is of the first type before receiving the first message; herein, data units are received via the second RLC bearer in the RRC_Inactive state; a type of the second RLC bearer is the second type.

In one embodiment, the first receiver 1001 stops monitoring of a physical downlink control channel addressed to the unicast RNTI in the RRC_Inactive state; herein, data units transmitted via an RLC bearer of the first type are scheduled by a physical downlink control channel addressed to the unicast RNTI.

In one embodiment, the first bearer is a multicast MRB.

In one embodiment, the first receiver 1001 comprises the receiver 454 (comprising the antenna 452), the receiving processor 456, the multi-antenna receiving processor 458 and the controller/processor 459 in FIG. 4 of the present application.

In one embodiment, the first receiver 1001 comprises at least one of the receiver 454 (comprising the antenna 452), the receiving processor 456, the multi-antenna receiving processor 458 or the controller/processor 459 in FIG. 4 of the present application.

In one embodiment, the first transmitter 1002 comprises the transmitter 454 (comprising the antenna 452), the transmitting processor 468, the multi-antenna transmitting processor 457 and the controller/processor 459 in FIG. 4 of the present application.

In one embodiment, the first transmitter 1002 comprises at least one of the transmitter 454 (comprising the antenna 452), the transmitting processor 468, the multi-antenna transmitting processor 457 or the controller/processor 459 in FIG. 4 of the present application.

### Embodiment 11

Embodiment 11 illustrates a structure block diagram of a processing device in a second node according to one embodiment of the present application, as shown in FIG. 11. In FIG. 11, a processing device in a second node 1100 is comprised of a second receiver 1101 and a second transmitter 1102; the second node 1100 is a base station.

In Embodiment 11, the second transmitter 1102 transmits a first message, the first message indicating an entry into RRC_Inactive state; herein, whether the receiver of the first message receives data units via a first RLC bearer in the RRC_Inactive state is related to whether the first message configures a first bearer and a type of the first RLC bearer; before receiving the first message the first RLC bearer is associated to the first bearer; when the first message does not configure the first bearer, data units are not received via the first RLC bearer in the RRC_Inactive state; when the first message configures the first bearer and the type of the first RLC bearer is a first type, data units are not received via the first RLC bearer in the RRC_Inactive state; when the first message configures the first bearer and the type of the first RLC bearer is a second type, data units are received via the first RLC bearer in the RRC_Inactive state; data units transmitted via an RLC bearer of the first type are identified by a unicast RNTI, while data units transmitted via an RLC bearer of the second type are identified by a non-unicast RNTI.

In one embodiment, the type of the first RLC bearer is used for updating an RLC bearer that is associated to the first bearer; herein, when the type of the first RLC bearer is the first type, the first RLC bearer is removed from the RLC bearer that is associated to the first bearer; when the type of the first RLC bearer is the second type, the association between the first RLC bearer and the first bearer is maintained.

In one embodiment, the type of the first RLC bearer is used for determining whether to deactivate the first RLC bearer; herein, the first RLC bearer is deactivated only when the type of the first RLC bearer is a former of the first type and the second type.

In one embodiment, the second receiver 1101 receives a second message, the second message being used for a request for resuming RRC connection; and the second transmitter 1102 transmits a third message as a response to receiving a second message, the third message indicating that the receiver of the first message enters into RRC_Connected state; herein, the first RLC bearer is activated; the type of the first RLC bearer is the first type.

In one embodiment, a second RLC bearer that is associated to the first bearer is added when the first bearer is associated only to the first RLC bearer and the first RLC bearer is of the first type before receiving the first message; herein, data units are received via the second RLC bearer in the RRC_Inactive state; a type of the second RLC bearer is the second type.

In one embodiment, a physical downlink control channel addressed to the unicast RNTI being not monitored by the receiver of the first message in the RRC_Inactive state; herein, data units transmitted via an RLC bearer of the first type are scheduled by a physical downlink control channel addressed to the unicast RNTI.

In one embodiment, the bearer of the first type includes a multicast MRB.

In one embodiment, the second receiver 1101 comprises the receiver 418 (comprising the antenna 420), the receiving processor 470, the multi-antenna receiving processor 472 and the controller/processor 475 in FIG. 4 of the present application.

In one embodiment, the second receiver 1101 comprises at least one of the receiver 418 (comprising the antenna 420), the receiving processor 470, the multi-antenna receiving processor 472 or the controller/processor 475 in FIG. 4 of the present application.

In one embodiment, the second transmitter 1102 comprises the transmitter 418 (comprising the antenna 420), the transmitting processor 416, the multi-antenna transmitting processor 471 and the controller/processor 475 in FIG. 4 of the present application.

In one embodiment, the second transmitter 1102 comprises at least one of the transmitter 418 (comprising the antenna 420), the transmitting processor 416, the multi-antenna transmitting processor 471 or the controller/processor 475 in FIG. 4 of the present application.

The ordinary skill in the art may understand that all or part of steps in the above method may be implemented by instructing related hardware through a program. The program may be stored in a computer readable storage medium, for example Read-Only-Memory (ROM), hard disk or compact disc, etc. Optionally, all or part of steps in the above embodiments also may be implemented by one or more integrated circuits. Correspondingly, each module unit in the above embodiment may be realized in the form of hardware, or in the form of software function modules. The present application is not limited to any combination of hardware and software in specific forms. The first-type communication node or UE or terminal in the present application includes but is not limited to mobile phones, tablet computers, notebooks, network cards, low-consumption equipment, enhanced MTC (eMTC) terminals, NB-IoT terminals, vehicle-mounted communication equipment, aircrafts, diminutive airplanes, unmanned aerial vehicles, telecontrolled aircrafts, etc. The second-type communication node or base station or network-side device in the present application includes but is not limited to macro-cellular base stations, micro-cellular base stations, home base stations, relay base station, eNB, gNB, Transmitter Receiver Point (TRP), relay satellite, satellite base station, airborne base station, test equipment like transceiving device simulating partial functions of base station or signaling tester and other radio communication equipment.

It will be appreciated by those skilled in the art that this disclosure can be implemented in other designated forms without departing from the core features or fundamental characters thereof. The currently disclosed embodiments, in any case, are therefore to be regarded only in an illustrative, rather than a restrictive sense. The scope of invention shall be determined by the claims attached, rather than according to previous descriptions, and all changes made with equivalent meaning are intended to be included therein.

What is claimed is:

1. A first node for wireless communications, comprising:
a first receiver, receiving a first message, the first message being RRCRelease, the first message comprising a suspendConfig field; and entering into RRC_Inactive state as a response to receiving the first message;
wherein whether to receive data units via a first RLC bearer in the RRC_Inactive state is related to whether the first message configures a first bearer and a type of the first RLC bearer; before receiving the first message the first RLC bearer is associated to the first bearer; when the first message does not configure the first bearer, data units are not received via the first RLC bearer in the RRC_Inactive state; when the first message configures the first bearer and the type of the first RLC bearer is a first type, data units are not received via the first RLC bearer in the RRC_Inactive state; when the first message configures the first bearer and the type of the first RLC bearer is a second type, data units are received via the first RLC bearer in the RRC_Inactive state; data units transmitted via an RLC bearer of the first type are identified by a unicast RNTI, while data units transmitted via an RLC bearer of the second type are identified by a non-unicast RNTI; that the first message configures the first bearer comprises that the first message comprises configuration information for an RLC bearer that is associated to the first bearer;
when the first message configures the first bearer and the type of the first RLC bearer is a first type, that data units are not received via the first RLC bearer in the RRC_Inactive state comprises:
receiving data units via an RLC bearer other than the first RLC bearer in the RRC_Inactive state; the RLC bearer other than the first RLC bearer is associated to the first bearer, and a type of the RLC bearer other than the first RLC bearer is the second type.

2. The first node according to claim 1, characterized in comprising:
the first receiver, updating an RLC bearer that is associated to the first bearer according to the type of the first RLC bearer as a response to receiving the first message;
wherein when the type of the first RLC bearer is the first type, the first RLC bearer is removed from the RLC bearer that is associated to the first bearer; when the type of the first RLC bearer is the second type, the association between the first RLC bearer and the first bearer is maintained.

3. The first node according to claim 1, characterized in comprising:
the first receiver, determining whether to deactivate the first RLC bearer according to the type of the first RLC bearer as a response to receiving the first message;
wherein the first RLC bearer is deactivated when the type of the first RLC bearer is the first type.

4. The first node according to claim 3, characterized in that
a first transmitter, transmitting a second message, the second message being used for a request for resuming RRC connection; and
the first receiver, receiving a third message as a response to transmitting a second message, the third message indicating that the first node enters into RRC_Connected state; and activating the first RLC bearer as a response to receiving the third message;
wherein the type of the first RLC bearer is the first type.

5. The first node according to claim 1, characterized in comprising:
the first receiver, as a response to receiving the first message, adding a second RLC bearer that is associated to the first bearer when the first bearer is associated only to the first RLC bearer and the first RLC bearer is of the first type before receiving the first message;
wherein data units are received via the second RLC bearer in the RRC_Inactive state; a type of the second RLC bearer is the second type.

6. The first node according to claim 1, characterized in comprising:
the first receiver, stopping monitoring of a physical downlink control channel addressed to the unicast RNTI in the RRC_Inactive state;
wherein data units transmitted via an RLC bearer of the first type are scheduled by a physical downlink control channel addressed to the unicast RNTI.

7. The first node according to claim 1, characterized in that the first bearer is a multicast MRB.

8. A second node for wireless communications, comprising:
a second transmitter, transmitting a first message, the first message being RRC Release, the first message comprising a suspendConfig field, the first message indicating an entry into RRC_Inactive state;
wherein whether a receiver of the first message receives data units via a first RLC bearer in the RRC_Inactive state is related to whether the first message configures a first bearer and a type of the first RLC bearer; before receiving the first message the first RLC bearer is associated to the first bearer; when the first message does not configure the first bearer, data units are not received via the first RLC bearer in the RRC_Inactive state; when the first message configures the first bearer and the type of the first RLC bearer is a first type, data units are not received via the first RLC bearer in the RRC_Inactive state; when the first message configures the first bearer and the type of the first RLC bearer is a second type, data units are received via the first RLC bearer in the RRC_Inactive state; data units transmitted via an RLC bearer of the first type are identified by a unicast RNTI, while data units transmitted via an RLC bearer of the second type are identified by a non-unicast RNTI; that the first message configures the first bearer comprises that the first message comprises configuration information for an RLC bearer that is associated to the first bearer;
when the first message configures the first bearer and the type of the first RLC bearer is a first type, that data units are not received via the first RLC bearer in the RRC_Inactive state comprises:
receiving data units via an RLC bearer other than the first RLC bearer in the RRC_Inactive state; the RLC bearer other than the first RLC bearer is associated to the first bearer, and a type of the RLC bearer other than the first RLC bearer is the second type.

9. The second node according to claim 8, characterized in that the type of the first RLC bearer is used for updating an RLC bearer that is associated to the first bearer as a response to the first message being received;
wherein when the type of the first RLC bearer is the first type, the first RLC bearer is removed from the RLC bearer that is associated to the first bearer; when the type of the first RLC bearer is the second type, the association between the first RLC bearer and the first bearer is maintained.

10. The second node according to claim 8, characterized in that the type of the first RLC bearer is used for determining whether to deactivate the first RLC bearer as a response to receiving the first message;
wherein the first RLC bearer is deactivated when the type of the first RLC bearer is the first type.

11. The second node according to claim 10, characterized in that
a second receiver, receiving a second message, the second message being used for a request for resuming RRC connection; and
the second transmitter, transmitting a third message as a response to receiving a second message, the third message indicating that the receiver of the first message enters into RRC_Connected state; and
wherein the first RLC bearer is activated as a response to the third message being received; the type of the first RLC bearer is the first type.

12. The second node according to claim 8, characterized in that as a response to the first message being received, a second RLC bearer that is associated to the first bearer is added when the first bearer is associated only to the first RLC bearer and the first RLC bearer is of the first type before the first message is received;
wherein the receiver of the first message receives data units via the second RLC bearer in the RRC_Inactive state; a type of the second RLC bearer is the second type.

13. The second node according to claim 8, characterized in that the bearer of the first type is a multicast MRB.

14. A method in a first node for wireless communications, comprising:
receiving a first message, the first message being RRCRelease, the first message comprising a suspendConfig field; and
entering into RRC_Inactive state as a response to receiving the first message;
wherein whether to receive data units via a first RLC bearer in the RRC_Inactive state is related to whether the first message configures a first bearer and a type of the first RLC bearer; before receiving the first message the first RLC bearer is associated to the first bearer; when the first message does not configure the first bearer, data units are not received via the first RLC bearer in the RRC_Inactive state; when the first message configures the first bearer and the type of the first RLC bearer is a first type, data units are not received via the first RLC bearer in the RRC_Inactive state; when the first message configures the first bearer and the type of the first RLC bearer is a second type, data units are received via the first RLC bearer in the RRC_Inactive state; data units transmitted via an RLC bearer of the first type are identified by a unicast RNTI, while data units transmitted via an RLC bearer of the second type are identified by a non-unicast RNTI; that the first message configures the first bearer comprises that the first message comprises configuration information for an RLC bearer that is associated to the first bearer;
when the first message configures the first bearer and the type of the first RLC bearer is a first type, that data units are not received via the first RLC bearer in the RRC_Inactive state comprises:
receiving data units via an RLC bearer other than the first RLC bearer in the RRC_Inactive state; the RLC bearer other than the first RLC bearer is associated to the first bearer, and a type of the RLC bearer other than the first RLC bearer is the second type.

15. The method in the first node according to claim 14, characterized in comprising:
updating an RLC bearer that is associated to the first bearer according to the type of the first RLC bearer as a response to receiving the first message;
wherein when the type of the first RLC bearer is the first type, the first RLC bearer is removed from the RLC bearer that is associated to the first bearer; when the type of the first RLC bearer is the second type, the association between the first RLC bearer and the first bearer is maintained.

16. The method in the first node according to claim 14, characterized in comprising:
determining whether to deactivate the first RLC bearer according to the type of the first RLC bearer as a response to receiving the first message;
wherein the first RLC bearer is deactivated when the type of the first RLC bearer is the first type.

17. The method in the first node according to claim 16, characterized in comprising:
transmitting a second message, the second message being used for a request for resuming RRC connection; and
receiving a third message as a response to transmitting a second message, the third message indicating that the first node enters into RRC_Connected state; and
activating the first RLC bearer as a response to receiving the third message;
wherein the type of the first RLC bearer is the first type.

18. The method in the first node according to claim 14, characterized in comprising:
as a response to receiving the first message, adding a second RLC bearer that is associated to the first bearer when the first bearer is associated only to the first RLC bearer and the first RLC bearer is of the first type before receiving the first message;
wherein data units are received via the second RLC bearer in the RRC_Inactive state; a type of the second RLC bearer is the second type.

19. The method in the first node according to claim 14, characterized in comprising:
stopping monitoring of a physical downlink control channel addressed to the unicast RNTI in the RRC_Inactive state;
wherein data units transmitted via an RLC bearer of the first type are scheduled by a physical downlink control channel addressed to the unicast RNTI.

20. The method in the first node according to claim 14, characterized in that the first bearer is a multicast MRB.
